(19) United States
(12) Patent Application Publication
(10) Pub. No.: US 2021/0350419 A1
(43) Pub. Date: Nov. 11, 2021

(54) METHOD AND SYSTEM FOR FACILITATING A PROVISIONING OF ADVERTISEMENTS TO CUSTOMERS

(71) Applicant: [24]7.ai, Inc., San Jose, CA (US)

(72) Inventors: Pallipuram V. Kannan, Saratoga, CA (US); Bhupinder Singh, Bangalore (IN); R. Mathangi Sri, Bangalore (IN)

(21) Appl. No.: 17/354,217

(22) Filed: Jun. 22, 2021

Related U.S. Application Data
(63) Continuation of application No. 15/621,172, filed on Jun. 13, 2017, now abandoned.
(60) Provisional application No. 62/351,882, filed on Jun. 17, 2016.

(51) Int. Cl. G06Q 30/02; H04L 29/08; H04M 3/51

(52) U.S. Cl. CPC G06Q 30/0276; H04L 67/02; H04L 67/20; H04W 4/23; G06Q 30/0267; G06Q 30/0272; H04M 3/5191; G06Q 30/0256

(57) ABSTRACT

A computer-implemented method and apparatus for facilitating a provisioning of advertisements to customers effects display of one or more advertisements on a Web domain. Each displayed advertisement is configured to offer advertisement related assistance to customers visiting the Web domain. A selection input provided by a customer on an advertisement is received. In response to the receipt of the selection input, the system facilitates customer engagement with a customer support representative associated with an enterprise related to the advertisement. The customer engagement facilitated through the advertisement is configured to provide the advertisement related assistance to the customer.

### CROSS REFERENCE TO RELATED APPLICATIONS

This application is a continuation of U.S. patent application Ser. No. 15/621,172, filed on Jun. 13, 2017, which claims priority to U.S. provisional patent application Ser. No. 62/351,882, filed Jun. 17, 2016, which documents are incorporated herein in their entirety by this reference thereto.

### TECHNICAL FIELD

The invention generally relates to digital advertising, and more particularly to a method and apparatus for facilitating a provisioning of advertisements to customers.

### BACKGROUND

Typically, most enterprises rely on digital advertising to communicate with existing and potential users of their products, services, and/or information offerings. The existing and potential users of enterprise offerings are referred to herein as customers of the respective enterprise. The enterprises display advertisements or ‘ads’ on enterprise channels, such as enterprise Websites, as well as on other non-enterprise channels, to attract customer traffic through their content. The display of ads on enterprise channels is referred to as ‘on-domain advertising,’ whereas the display of advertisements on non-enterprise channels is referred to as ‘off-domain advertising.’ An example of a non-enterprise channel may include a third-party Website. Some examples of third-party Websites include retailer Websites, Websites of e-commerce entities, news related Websites, search engine related Websites, and the like.

The on-domain or off-domain ads may include content designed to attract customers, some of whom may purchase the enterprise offerings displayed on the ads. The effectiveness of on-domain or off-domain ads or a campaign of ads is typically monitored in terms of standard metrics, such as a click through rate, a conversion rate, and the like. Moreover, revenue accrued from these ads is optimized by attempting to segment the customers through third-party or on-domain data, so that the most appropriate advertisement is displayed to the correct target audience. In many example scenarios, the customer may have queries regarding the efficacy of the displayed product or service and/or may need additional information prior to initiating a purchase transaction. However, currently there is no mechanism to get assistance with the purchase through the advertisement. The customer may have to seek answers to the queries separately, which may be cumbersome for the customer and, in many cases, the customer may not pursue clicking on the ads or initiate engagement with the enterprise.

### SUMMARY

In an embodiment of the invention, a computer-implemented method for facilitating provisioning of advertisements to customers is disclosed. The method effects, by a processor, a display of at least one advertisement on a Web domain. Each advertisement from among the at least one advertisement offers respective advertisement related assistance to a customer visiting the Web domain. The method receives, by the processor, a selection input provided by the customer in relation to an advertisement from among the at least one advertisement. The method in response to the selection input provided by the customer facilitates, by the processor, a customer engagement with a customer support representative associated with an enterprise related to the advertisement. The customer engagement is configured to provide the advertisement related assistance to the customer. This automates customer engagement, thus reducing system resource use and latency, while improving the customer experience.

In another embodiment of the invention, an apparatus for facilitating provisioning of advertisements to customers is disclosed. The apparatus includes at least one processor and a memory. The memory has stored therein machine executable instructions, that when executed by the at least one processor, cause the apparatus to effect a display of at least one advertisement on a Web domain. Each advertisement from among the at least one advertisement offers respective advertisement related assistance to a customer visiting the Web domain. The apparatus receives a selection input provided by the customer in relation to an advertisement from among the at least one advertisement. The apparatus in response to the selection input provided by the customer facilitates a customer engagement with a customer support representative associated with an enterprise related to the advertisement. The customer engagement is configured to provide the advertisement related assistance to the customer. This automates customer engagement, thus reducing system resource use and latency, while improving the customer experience.

In another embodiment of the invention, a computer-implemented method for facilitating provisioning of advertisements to customers is disclosed. The method effects, by a processor, display of at least one advertisement on an electronic device of a customer of an enterprise. Each advertisement from among the at least one advertisement offers respective advertisement related assistance to the customer. The method receives, by the processor, a selection input provided by the customer in relation to an advertisement from among the at least one advertisement. The method in response to the selection input provided by the customer facilitates, by the processor, a customer engagement with a customer support representative associated with the enterprise related to the advertisement. The customer engagement is configured to provide the advertisement related assistance to the customer. This automates customer engagement, thus reducing system resource use and latency, while improving the customer experience.

### BRIEF DESCRIPTION OF THE FIGURES

FIG. 1 is a block diagram illustrating a provisioning of an advertisement to a customer according to the invention;

FIG. 2 depicts an example advertisement displayed on a device of a customer according to the invention;

FIG. 3 is a block diagram of a system configured to facilitate a provisioning of advertisements to customers according to the invention;

FIG. 4 shows an example advertisement capable of providing advertisement related assisted to the customer is shown according to the invention;

FIG. 5 shows an example advertisement capable of providing advertisement related assisted to the customer according to the invention;

FIG. 6 depicts an example representation of customer engagements facilitated by the system of FIG. 3 according to the invention;

FIG. 7 depicts a block diagram of an advertisement network connecting enterprises to prospective customers according to the invention; and

FIG. 8 is a flow diagram of an example method for facilitating provisioning of advertisements to a customer according to the invention.

### DETAILED DESCRIPTION

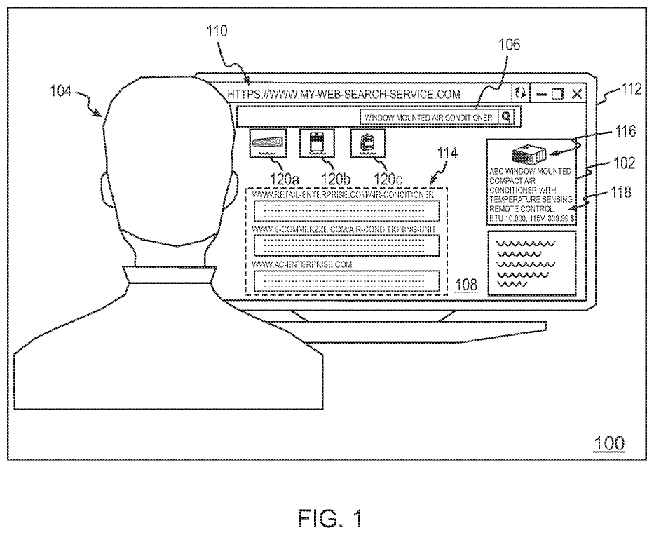

FIG. 1 depicts a representation 100 of an embodiment of the invention for a provisioning of an advertisement 102 to a customer 104. In FIG. 1, the customer 104 wishing to purchase an air conditioning unit may enter a textual input such as, for example, a ‘window mounted air conditioner’ in a search box 106 displayed on a Website 108. In the representation 100, the website 108 is depicted to be Web search engine service providing the Website. Some examples of such a Website include Websites related to search engines from Google®, Yahoo!®, and Microsoft®. The Website 108 is depicted to be a Web search engine service providing Website for illustration purposes. In some embodiments, the Website 108 may correspond to a Website offered by an e-commerce entity, a retailer, a news Website, or any other Website offered by a private or a public enterprise.

The customer 104 may access the Website 108 using a Web browser application 110 on a customer device, exemplarily depicted to be a desktop computer 112. The customer 104 may alternatively use any other electronic device, such as a smartphone, a mobile phone, a tablet device, a laptop computer, a Web-enabled wearable device, and the like to access the Website 108. The Website 108 may be hosted on a remote Web server and the Web browser application 110 may be configured to retrieve one or more Web pages associated with the Website 108 from the remote Web server over a network (not shown in FIG. 1). Examples of the network may include wired networks, wireless networks, and combinations thereof. Some examples of the wired networks include Ethernet, local area networks (LAN), fiber-optic cable networks, and the like. Some examples of the wireless networks include cellular networks such as GSM/3G/4G/CDMA networks, wireless LANs, Bluetooth or Zigbee networks, and the like. Some examples of combination of the wired and wireless networks include the Internet, cloud based networks, and the like. The Website 108 may attract a large number of existing and potential customers, such as the customer 104.

In response to the textual input of the customer 104 in the search box 106, one or more uniform resource locators (URLs) of Websites associated with content related to air conditioning units may be presented to the customer 104, as exemplarily displayed in the text section 114. Further, one or more advertisements, such as the advertisement 102, may be displayed to the customer 104, such as advertisements 120a, 120b and 120c. The advertisements may be provided, in some embodiments based on a match of words in the customer's textual input and the textual content associated with the advertisement. In some embodiments, in addition to matching words, a relevance of the advertisements to the textual input provided by the customers may be determined using well-known algorithms configured to interpret context from textual inputs and accordingly, one or more advertisements may be offered to the customers, such as the customer 104.

The advertisement 102 displayed to the customer 104 includes content related to a home air conditioning unit offered for sale by an enterprise ABC. The advertisement 102 is depicted to display an image 116 of the air conditioning unit and a text portion 118 including text such as ‘ABC Window-Mounted Compact Air Conditioner with Temperature Sensing Remote Control, BTU 10,000, 115V, 339.99 $.’ In an embodiment, the customer 104 may have several questions in response to the content displayed by the advertisement 102. For example, the customer 104 may wish to know the dimensions of the air conditioning unit to evaluate whether the air conditioning unit can be safely mounted on the customer's window without any wall-modifications. In another illustrative example, the customer 104 may wish to know an energy rating of the air conditioning unit and how much the air conditioning unit would contribute to the monthly electricity bills.

The advertisements, such as the advertisement 102, are designed to attract a customer's attention and their primary aim is to persuade the customer to click on the advertisements so that the customer can then be directed to another Website, where product specifications along with other details may be displayed to the customer, such as, for example, delivery options, EMI options, etc. In many scenarios, the customer, even though interested in the content associated with the advertisement, may choose to ignore the advertisements because there is currently no mechanism to offer assistance to the customer through advertisements. The customer may have to visit other Websites or initiate communication with customer support representatives of the enterprise associated with the advertisement to seek answers to the queries, which may be cumbersome for the customer. In many cases, the customer may opt to not pursue clicking on the ads or initiate engagement with the enterprise, leading to revenue loss for the enterprise.

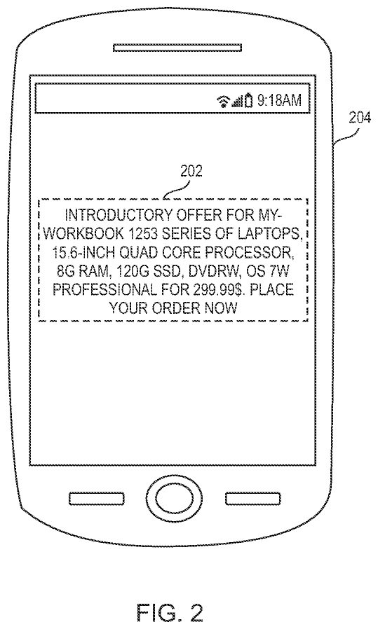

In FIG. 1, the advertisement 102 corresponds to an off-domain advertisement or, more specifically, the advertisement 102 related to an offering from enterprise ABC is displayed on a Web domain other than the Web domain corresponding to the enterprise ABC. The term ‘Web domain’ and ‘Website’ are used interchangeably herein. Further, advertisements, such as the advertisement 102, may also be displayed on the Websites of the enterprises associated with the offering displayed on the respective advertisements. For example, advertisement 102 may be displayed on the Website of the enterprise ABC, such as for example ‘www.enterprise-abc.com,’ in a similar or a different form than that depicted in the representation 100 in FIG. 1. Another example of off-domain advertising is depicted in FIG. 2.

FIG. 2 depicts an example advertisement 202 displayed on a device 204 of a customer in accordance with another embodiment of the invention. The advertisement 202 is depicted to be a short messaging service (SMS) advertisement for a laptop computer. More specifically, the advertisement 202 is depicted to be a text message stating ‘Introductory offer for My-Workbook 1253 Series of Laptops, 15.6-Inch Quad Core Processor, 8G RAM, 120G SSD, DVDRW, OS 7 W Professional for 299.99$. Place your order now.’ In an embodiment, the advertisement 202 may be a part of a mass mailing SMS campaign, whereby SMS notifications are sent to a list of prospective customers. It is noted that the advertisement 202 is depicted as a SMS advertisement for illustrative purposes. In some embodiments, the advertisement 202 may be an electronic mail (Email) advertisement, for example a mailer including a URL linking to a corresponding enterprise Webpage, or any multimedia advertisement involving image and/or audio/video content. Moreover, such advertisements may also be configured to be received on other devices, such as personal computers, tablet devices, wearable devices, personal digital assistants, and the like.

In an embodiment, a customer viewing the advertisement 202 may have several questions in response to the content displayed in the advertisement 202. For example, the customer may wish to know what color options are available for the advertised series of laptop computers. In another illustrative example, the customer may wish to know if the laptop computer has a HDMI (High-Definition Multimedia Interface) port or not. Even though the customer may be interested in purchasing the advertised laptop, or at least in learning more about the laptop, the customer may choose to ignore the advertisement because currently there is no mechanism to address queries that the customer may have through the advertisement.

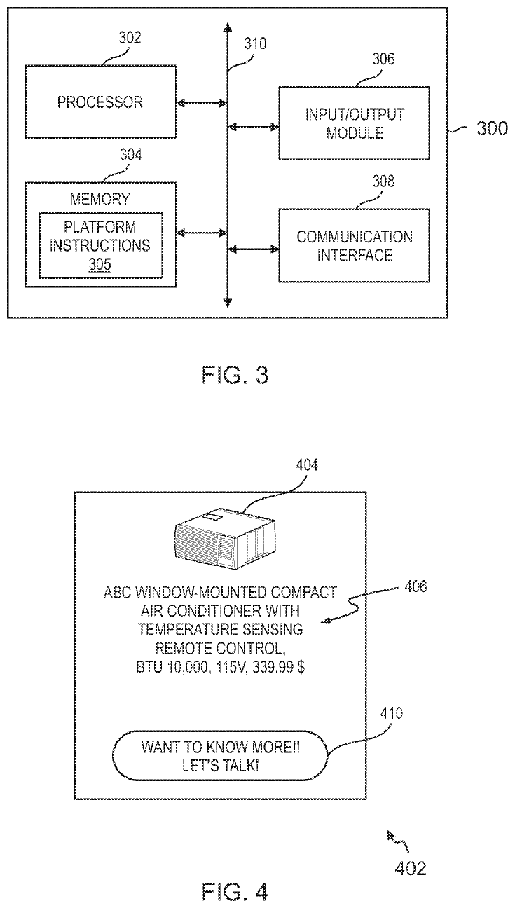

Various embodiments of the invention provide a method and apparatus that are capable of overcoming these and other obstacles and providing additional benefits. More specifically, various embodiments of the invention disclosed herein suggest provisioning of advertisements that are capable of providing assistance to the customers. More specifically, the advertisements are configured in such a manner that the customer may click on the advertisement and connect to a customer support representative to have queries answered or receive additional information related to a product or service being advertised, almost instantly. As a result, the customer may be more inclined to click on the ads and, in many cases, purchase the advertised offering, thereby improving a customer's interaction experience as well as increasing revenues of the enterprises, while making more efficient use of the network infrastructure and systems associated therewith. A system for facilitating a provisioning of advertisements to customers is explained with reference to FIG. 3.

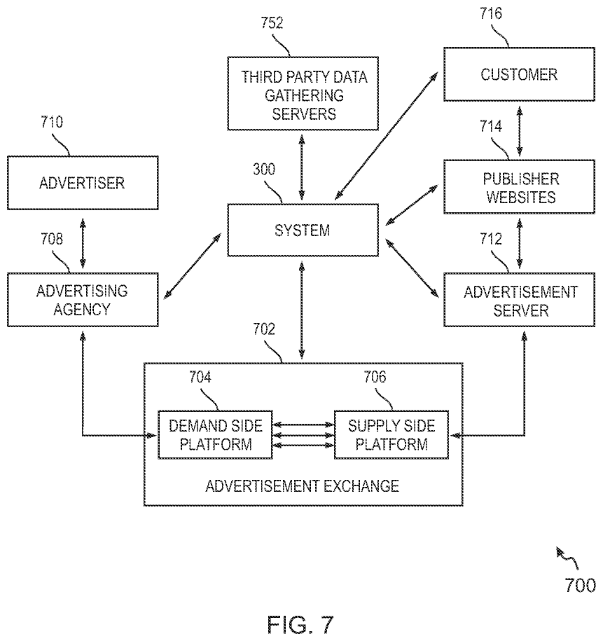

FIG. 3 is a block diagram of a system 300 configured to facilitate a provisioning of advertisements to customers in accordance with an embodiment of the invention. The advertisements or ‘ads’ provisioned to the customers enable the customers to seek assistance from customer support representatives through the advertisement itself. In an embodiment, the system 300 is embodied as an interaction platform with one or more components of the system 300 implemented as a set of software layers on top of existing hardware systems. The interaction platform may be communicably coupled over a communication network with supply-side advertisement networks and demand-side advertisement networks, as will be explained later with reference to FIG. 7. The interaction platform may also be communicably coupled with on-domain and off-domain interaction channels, such as enterprise Websites and non-enterprise Websites. In some embodiments, the interaction platform may also be communicably associated with personal devices of the customers of the one or more enterprises and configured to receive information related to customer-enterprise interactions from the personal devices of the customers.

The system 300 includes at least one processor, such as a processor 302 and a memory 304. Although the system 300 is depicted to include only one processor, the system 300 may include more number of processors therein. In an embodiment, the memory 304 stores machine executable instructions, referred to herein as platform instructions 305. Further, the processor 302 executes the platform instructions 305. In an embodiment, the processor 302 may be embodied as a multi-core processor, a single core processor, or a combination of one or more multi-core processors and one or more single core processors. For example, the processor 302 may be embodied as one or more of various processing devices, such as a coprocessor, a microprocessor, a controller, a digital signal processor (DSP), a processing circuitry with or without an accompanying DSP, or various other processing devices including integrated circuits such as, for example, an application specific integrated circuit (ASIC), a field programmable gate array (FPGA), a microcontroller unit (MCU), a hardware accelerator, a special-purpose computer chip, or the like. In an embodiment, the processor 302 may be configured to execute hard-coded functionality. In an embodiment, the processor 302 is embodied as an executor of software instructions, wherein the instructions may specifically configure the processor 302 to perform the algorithms and/or operations described herein when the instructions are executed.

The memory 304 may be embodied as one or more volatile memory devices, one or more non-volatile memory devices, and/or a combination of one or more volatile memory devices and non-volatile memory devices. For example, the memory 304 may be embodied as magnetic storage devices, such as hard disk drives, floppy disks, magnetic tapes, etc.; optical magnetic storage devices, e.g. magneto-optical disks; CD-ROM (compact disc read only memory), CD-R (compact disc recordable), CD-R/W (compact disc rewritable), DVD (Digital Versatile Disc), BD (BLU-RAY® Disc); and semiconductor memories, such as mask ROM, PROM (programmable ROM), EPROM (erasable PROM), flash memory, RAM (random access memory), etc.

The system 300 also includes an input/output module 306 (hereinafter referred to as ‘I/O module 306’) and at least one communication interface, such as the communication interface 308. In an embodiment, the I/O module 306 may include mechanisms configured to receive inputs from and provide outputs to the user of the system 300. To that effect, the I/O module 306 may include at least one input interface and/or at least one output interface. Examples of the input interface may include, but are not limited to, a keyboard, a mouse, a joystick, a keypad, a touch screen, soft keys, a microphone, and the like. Examples of the output interface may include, but are not limited to, a display such as a light emitting diode display, a thin-film transistor (TFT) display, a liquid crystal display, an active-matrix organic light-emitting diode (AMOLED) display, a microphone, a speaker, a ringer, a vibrator, and the like.

In an example embodiment, the processor 302 may include I/O circuitry configured to control at least some functions of one or more elements of the I/O module 306, such as, for example, a speaker, a microphone, a display, and/or the like. The processor 302 and/or the I/O circuitry may be configured to control one or more functions of the one or more elements of the I/O module 306 through computer program instructions, for example, software and/or firmware, stored on a memory, for example, the memory 304, and/or the like, accessible to the processor 302.

The communication interface 308 may include several channel interfaces to receive information from a plurality of on-domain and off-domain interaction channels. For an enterprise for which the ads are to be provisioned to the customers, the interaction channels related to the enterprise are referred to herein as ‘on-domain’ enterprise interaction channels. Some non-exhaustive examples of such interaction channels may include a Web channel, i.e. an enterprise Website; a voice channel, i.e. voice-based customer support offered by the enterprise; a chat channel, i.e. a chat support offered by the enterprise; a native mobile application channel; and the like. For example, if an ad of an enterprise ABC is displayed on a Website ‘www.enterprise-abc.com’ associated with the enterprise, then the Website corresponds to an on-domain enterprise interaction channel and the ad corresponds to an on-domain advertisement. Similarly, for an enterprise for which the ads are to be provisioned to the customers, the interaction channels not related to the enterprise are referred to herein as ‘off-domain’ enterprise interaction channels. For example, if an ad of a telecom-enterprise XYZ is displayed on an e-commerce Website www.ecommerce-enterprise.com; then the Website corresponds to an off-domain enterprise interaction channel and the ad corresponds to an off-domain advertisement.

As explained above, the communication interface 308 may include several channel interfaces to receive information from a plurality of on-domain and off-domain interaction channels. Each interaction channel interface of the communication interface 308 may be associated with a respective communication circuitry such as, for example, a transceiver circuitry including an antenna and other communication media interfaces to connect to a wired and/or wireless communication network. The communication circuitry associated with each channel interface may, in at least some example embodiments, enable transmission of data signals and/or reception of signals from remote network entities, such as Web servers hosting enterprise and non-enterprise Websites, advertisement servers configured to display advertisements on Websites, servers associated with advertisement platforms configured to facilitate bidding between enterprises for placement of advertisements or servers deployed at enterprise customer support and service centers configured to maintain real-time information related to interactions between customers and customer support representatives (also referred to as agents).

In at least some embodiments, the communication interface 308 may include relevant Application Programming Interfaces (APIs) to communicate with various customer touch points, such as electronic devices associated with the customers, Websites visited by the customers, devices used by customer support representatives, for example voice agents, chat agents, IVR systems, in-store agents, and the like, engaged by the customers and the like.

In an embodiment, various components of the system 300, such as the processor 302, the memory 304, the I/O module 306, and the communication interface 308 are configured to communicate with each other via or through a centralized circuit system 310. The centralized circuit system 310 may be various devices configured to, among other things, provide or enable communication between the components (302-308) of the system 300. In certain embodiments, the centralized circuit system 310 may be a central printed circuit board (PCB), such as a motherboard, a main board, a system board, or a logic board. The centralized circuit system 310 may also, or alternatively, include other printed circuit assemblies (PCAs) or communication channel media. In some embodiments, the centralized circuit system 310 may include appropriate storage interfaces to facilitate communication between the processor 302 and the memory 304. Some examples of the storage interface may include, for example, an Advanced Technology Attachment (ATA) adapter, a Serial ATA (SATA) adapter, a Small Computer System Interface (SCSI) adapter, a RAID controller, a SAN adapter, a network adapter, and/or any component providing processor 302 with access to the data stored in the memory 304.

The system 300 as illustrated and hereinafter described is merely illustrative of an apparatus that could benefit from embodiments of the invention and, therefore, should not be taken to limit the scope of the invention. The system 300 may include fewer or more components than those depicted in FIG. 3. In an embodiment, one or more components of the system 300 may be deployed in a Web Server. In another embodiment, the system 300 may be a standalone component in a remote machine connected to a communication network and capable of executing a set of instructions (sequential and/or otherwise) to facilitate provisioning of advertisements to customers. Moreover, the system 300 may be implemented as a centralized system or, alternatively, the various components of the system 300 may be deployed in a distributed manner while being operatively coupled to each other. In an embodiment, one or more functionalities of the system 300 may also be embodied as a client within devices, such as customers' devices. In another embodiment, the system 300 may be a central system that is shared by or accessible to each of such devices.

The provisioning of advertisements by the system 300 is hereinafter explained with reference to provisioning of an advertisement to one customer of an enterprise. The system 300 may be caused to provision advertisements to several customers of the enterprise in a similar manner.

In at least one example embodiment, the processor 302 is configured to, with the content of the memory 304, cause the system 300 to effect a display of at least one advertisement on a Web domain. The Web domain may correspond to an on-domain Website or an off-domain Website. Accordingly, one or more advertisements displayed on the Web domain may correspond an off-domain advertisement or an on-domain advertisement. As explained above, the communication interface 308 may be configured to be in operative communication with Web servers hosting Websites, such as the enterprise Website and other non-enterprise Websites. The processor 302 may be configured to cause display of one or more advertisements on a Web domain using the communication interface 308. The advertisements displayed on the Web domain may be configured to offer respective advertisement related assistance to customers visiting the Web domain.

In one embodiment, the one or more advertisements may be displayed on the Web domain to a customer in response to a textual input provided by the customer on the Web domain. An example advertisement displayed to a customer on a Web domain by the system 300 is depicted in FIG. 4.

Referring now to FIG. 4, an example advertisement 402 capable of providing advertisement related assisted to the customer is shown, in accordance with an embodiment of the invention. The advertisement 402 is similar to the advertisement 102 depicted in FIG. 1. Further, the advertisement 402 may be displayed on an on-domain Website, such as Website associated with the enterprise ABC, or an off-domain Website, such as the Website 108 explained with reference to FIG. 1. The advertisement 402 may be displayed to all customers visiting the Web domain or, in some cases, may be displayed to a customer in response to a textual input provided by the customer on the Web domain. For example, the customer may provide a textual input ‘Window mounted AC’ in a search box provided on the Web domain and the UI associated with the Web domain may be refreshed to display a UI such as the UI shown in FIG. 1. The UI may include one or more advertisements, such as the advertisement 402.

The advertisement 402 is depicted to display an image 404 of the air conditioning unit and a text portion 406 including text such as ‘ABC Window-Mounted Compact Air Conditioner with Temperature Sensing Remote Control, BTU 10,000, 115V, 339.99 $.’ Additionally, the advertisement 402 is depicted to display a button 410 capable of receiving a selection input by a customer. The button 410 is depicted to display text ‘Want to know more!! Let's talk!’ The button 410 displayed on the advertisement 402 is configured to connect the customer to a customer support representative of the enterprise ABC associated with the air-conditioning unit, thereby providing advertisement related assistance to the customer.

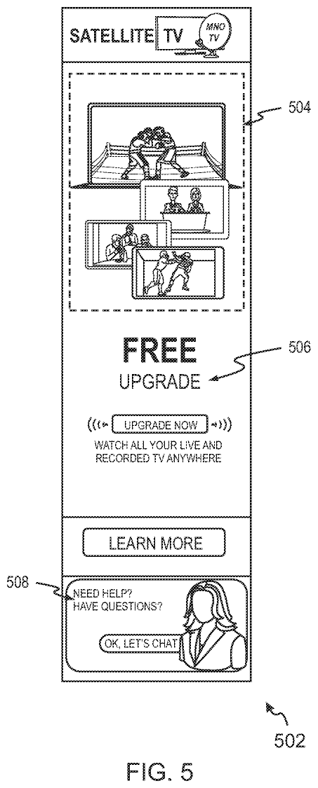

Provisioning of advertisements to customers may not be limited to Web domains. Other enterprise and non-enterprise interaction channels, such as a short messaging service (SMS) channel or the electronic mail (Email) channel, may also be used for provisioning of advertisements offering advertisement related assistance to customers. One such example of advertisement provisioned to a customer on a non-Web domain channel is depicted in FIG. 5.

FIG. 5 shows an example advertisement 502 capable of providing advertisement related assisted to the customer in accordance with an embodiment of the invention. In one embodiment, the advertisement 502 may correspond to a SMS advertisement or an email advertisement. To that effect, the display of the advertisement 502 may be effected on a personal device of the customer. The term ‘customer’ as explained above refers to both existing and potential users of enterprise product/service/information offerings. Some non-exhaustive examples of the personal device of the customer may include electronic devices such as a smartphone, a laptop, a tablet device, a wearable device, a desktop computer, a workstation terminal, and the like. As explained with reference to FIG. 3, the communication interface 308 of the system 300 is in operative communication with customer touch points, such as personal electronic devices, and may be configured to effect display of advertisements on the personal electronic devices of the customers.

The advertisement 502 relates to an upgrade offer by an enterprise MNO for its satellite TV/media broadcast services. Accordingly, the advertisement 502 is depicted to include image content 504 and a textual content 506 informing customers of the upgrade offer. The advertisement 502 is further depicted to include a section 508 offering assistance to the customer. As an illustrative example, the section 508 is depicted to display text ‘Need Help? Have Questions? Ok Let's Chat.’ The customer can click on the advertisement to initiate a chat interaction with an agent of the enterprise MNO.

Referring now to FIG. 3, in at least one example embodiment, the processor 302 is configured to, with the content of the memory 304, cause the system 300 to receive a selection input provided by a customer in relation to an advertisement displayed to the customer. For example, the customer may provide a touch or a click input on the advertisement 402 or on the advertisement 502 shown in FIGS. 4 and 5, respectively. In some embodiments, the selection input may be provided specifically on the portion offering assistance such as, for example, on the button 410 of the advertisement 402 or on the section 508 of the advertisement 502.

In at least some embodiments, all components on the Web domain including the advertisement 402 and/or the button 410 may be associated with tags, such as JavaScript or Hypertext Markup Language (HTML) tags. The selection input on the advertisement 402 or the button 410 may be recorded using the tags, which may be configured to generate an application programming interface (API) call. The communication interface 308 of the system 300 may be configured to receive the API call indicative of the selection input provided by the customer. The communication interface 308 may be configured to communicate the receipt of the selection input to the processor 302.

Similarly, the advertisements embodied as SMS ads or email ads may be associated with hyperlinks capable of recording the customer selection input and directing the input to the communication interface 308 which, in turn, may be configured to communicate the receipt of the selection input to the processor 302.

In response to the selection input provided by the customer, in at least one example embodiment, the processor 302 is configured to, with the content of the memory 304, cause the system 300 to facilitate a customer engagement with a customer support representative associated with an enterprise related to the advertisement. The customer engagement may be configured to provide the advertisement related assistance to the customer. The type of engagement may be in form of a chat interaction with a human agent, a voice conversation with a human agent, a chat interaction with a virtual (i.e. automated) agent, an interactive voice response (IVR) based interaction with the automated agent, and the like.

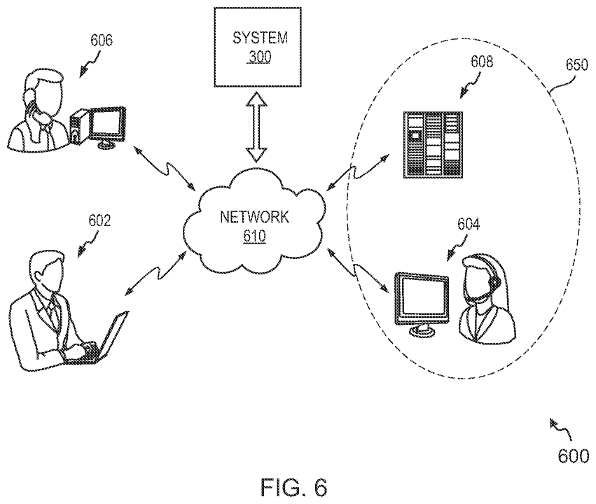

As explained with reference to FIG. 3, the communication interface 308 is in operative communication with servers associated with customer support centers to facilitate connecting a customer to a server at a customer support center of an enterprise. The server at the customer support center may be capable of routing the customer to an appropriate human/virtual agent. An example representation of customer engagements facilitated by the system 300 is depicted in FIG. 6.

FIG. 6 depicts an example representation 600 of customer engagements facilitated by the system 300 in accordance with an embodiment. As explained with reference to FIGS. 3, 4, and 5, the system 300 may be configured to effect display of advertisements offering advertisement related assistance to customers of an enterprise. The advertisements may be displayed on on-domain or off-domain Websites or as SMS/email advertisements on personal electronic devices of the customers.

In some embodiments, one or more advertisements may be displayed to a customer on a Web domain in response to a textual input provided by the customer on the Web domain. The customer may provide a selection input on an advertisement. The system 300 may be configured to receive the selection input (for example, by using the communication interface 308) and facilitate customer engagement by connecting the customer to a human/virtual agent of a customer support facility associated with an enterprise. The representation 600 depicts the system 300 connecting a customer 602 with a human agent 604 over a communication network 610, such as the network explained with reference to FIG. 1, to facilitate a chat engagement between the customer 602 and the human agent 604 of the customer support center 650 of an enterprise. Similarly, the representation 600 further depicts the system 300 connecting a customer 606 with a virtual agent 608 (depicted as a machine in FIG. 6) to facilitate an IVR based voice interaction between the customer 606 and the virtual agent 608 of the customer support center 650. As explained above, the processor 302, subsequent to receiving the selection input, may cause routing of the interaction request to a server associated with a customer support center, which may identify a suitable agent for interacting with the customer. In some embodiments, interactions such as the chat interaction may be initiated on the on-domain or off-domain Website itself or, in some embodiments, the customer may be directed to an enterprise Website for facilitating the chat interaction with the agent. For example, if a customer provides a selection input on the section 508 of the advertisement 502 (shown in FIG. 5), then the customer may be directed to the Website of the enterprise MNO and a chat console may be depicted on the Website to initiate a customer interaction with the agent.

Such interactive engagements enabled through advertisements improves the customer experience as the customer queries are answered instantly and the customer does not have to make an effort to reach out to an enterprise representative or separately seek answers to questions. Such offers for interactive engagements enabled through advertisements also increases the conversion rate for the ads. In at least one example embodiment, the type of assistance, i.e. live chat, interactive voice response (IVR) or virtual assistance, for example automated agents, such as chatbots, can be suited to the segment to which a particular customer belongs. Such interactive engagements enabled through advertisements also enable off-domain servicing of customers globally and not specifically customers visiting a particular domain.

Referring now to FIG. 3, in at least some embodiments, the system 300 is configured to track customer activity on the various interaction channels and store information related to the activity of the customers in a database (not shown) in the memory 304. For example, information captured corresponding to a activity of a customer on a Website of an enterprise may include information, such as Web pages visited, time spent on each Web page, menu options accessed, drop-down options selected or clicked, mouse movements, hypertext mark-up language (HTML) links those which are clicked and those which are not clicked, focus events (for example, events during which the customer has focused on a link/Webpage for a more than a pre-determined amount of time), non-focus events (for example, choices the customer did not make from information presented to the customer (for examples, products not selected) or non-viewed content derived from scroll history of the visitor), touch events (for example, events involving a touch gesture on a touch-sensitive device such as a tablet), non-touch events and the like. It is understood that an enterprise may use tags, such as HTML tags or JavaScript tags on the various elements of the Website or, alternatively, the enterprise may open up a socket connection to capture information related to customer activity on a Website.

In another illustrative example, a customer may engage in a chat interaction with an agent, i.e. a customer service representative, of the enterprise. In such a scenario, conversational content related to the chat conversation, including information such as a type of customer concern, which agent handled the chat interaction, customer concern resolution status, time involved in the chat interaction, and the like, may be captured and stored in the database. A channel interface of the communication interface 308 may be communicably associated with customer support facility housing several customer support representatives, to receive information related to customer voice conversations and chat conversations with various agents of the enterprise.

In an embodiment, the processor 304 is configured to identify at least one persona type for each customer based on the information collated corresponding to the customer. The term ‘persona type’ or ‘persona’ as used interchangeably hereinafter refers to characteristics reflecting behavioral patterns, goals, motives, and personal values of the customer. The term ‘personas’ as used herein is distinct from the concept of user profiles that are used in various kinds of analytics, where similar groups of customers are identified based on certain commonality in their attributes, which may not necessarily reflect behavioral similarity, or similarity in goals and motives. An example of a customer persona type may be a ‘convenience customer’ that corresponds to a group of customers characterized by the behavioral trait that they are focused and are looking for expeditious delivery of service. In an embodiment, a behavioral trait as referred to herein corresponds to a biological, sociological or a psychological characteristic. An example of a psychological characteristic may be a degree of decidedness associated with a customer while making a purchase. For example, some customers dither for a long time and check out various options multiple times before making a purchase, whereas some customers are more decided in their purchasing options. An example of a sociological characteristic may correspond to a likelihood measure of a customer to socialize a negative sentiment or an experience. For example, a customer upon having a bad experience with a product purchase may share the experience on social networks and/or complain bitterly on public forums, whereas another customer may choose to return the product and opt for another product, while precluding socializing the experience. An example of a biological characteristic may correspond to gender or age-based inclination towards consumption of products/services or information. For example, a middle aged female may be more likely to purchase a facial product associated with ageing, whereas a middle aged man may be more likely to purchase a hair care related product. It is noted that examples of customer biological, sociological, and psychological characteristics are provided herein for illustrative purposes and may not be considered limiting the scope of set of behavioral traits associated with a persona type and that each person type may include one or more such behavioral traits.

Some non-limiting examples of persona types identified for customers include a researcher, for example a customer who is likely to thoroughly investigate alternative products before making a purchase and read and compare product specifications; a loyal customer, for example a customer with a strong affinity to a single or a selected few brands or products or services; a convenience customer, for example a customer who is decided on what he wants and who is wanting to make a purchase quickly; a compulsive buyer, for example a customer who has high propensity to buy products he might not have a need for and who is very likely to agree to an up-sell/cross-sell offer made by an agent; a deal seeker, for example, a customer who is seeking motivation to get the best available deal or discount for a product or purchase; a stump, for example a customer who is convinced against making a purchase and is very unlikely to make a purchase regardless of the quality or timeliness of customer service; and the like.

In an embodiment, a number of customer persona classification frameworks or taxonomies capable of facilitating a segregation of customers based on customer personas types may be stored in the memory 304. In an embodiment, one or more persona types may be predicted for each customer based on behavioral traits exhibited by the customer during various interactions with the enterprise. More specifically, the processor 302 is configured to analyze the information collated corresponding to the customer to identify behavioral traits associated with the customer during various interactions of the customer with the enterprise. The behavioral traits exhibited, mentioned, inferred, or predicted based on past interaction history may be compared with sets of behavioral traits associated with the plurality of persona types in a customer persona classification framework to identify a presence of a match. The matching persona type may then be identified as a persona type of the customer. The identified persona type may be a single persona, or an aggregation of all historic personas over specified durations or time or over N previous interactions.

In an embodiment, the processor 302 may be configured to determine a relation between actions of customers associated with a particular persona type and their likelihood or propensity to engage with a customer support representative and/or their propensity to purchase an enterprise offering. In an illustrative example, the processor 302 may be configured to determine a relationship between a particular search key word input by a customer of a persona type ‘discount seeker’ and the propensity to engage in a customer interaction and/or purchase a product. For example, textual input including words ‘window mounted air conditioner’ from a customer associated with a persona type ‘discount seeker’ may be associated with ‘0.9’ measure of likelihood, i.e. a 90% probability of engaging in ‘chat interaction with an agent.’ Accordingly, advertisements enabled with appropriate type of assistance may be offered to prospective customers.

In an illustrative example, a prospective customer may visit a non-enterprise related Web domain and provide a textual input indicative of a customer's desire to purchase a product offered by the enterprise. The system 300 may be configured to receive such enterprise related textual input provided by the customers. The system 300 may also receive other information, such as user browser, operating system, IP address, and such other information related to the customer from the Web server hosting the non-enterprise related Website. The system 300 may try to identify the customer based on the received information, or at least categorize the customer in one of several categories, based on similarity of traits, such as location, browser, operating system, etc.

In at least one example embodiment, the system 300 may be configured to predict at least one persona for the customer based at least in part on the textual input. For example, a text-based processing of the textual input may be performed by the processor 302 to generate a plurality of features. In an embodiment, at least one of text tokenization, text normalization, and text vectorization on elements of the textual input are performed for text-based processing of the textual input to generate the plurality of features. In an embodiment, the text-based processing of the textual input may involve performing tokenization, i.e. splitting, of the textual input to generate tokens. The tokens may be subjected to one or more of text normalization techniques including spell correction, string replacements, replacements to specific word classes using Wordnets/thesaurus, stripping spaces, removing punctuations, removing numbers or replacing them by word classes, stemming, stop-word removal, point of sale (POS) tagging, and the like. The text vectorization may be performed using at least one of binary vectorizer, count vectorizer, Term frequency Inverse document frequency (TFIDF) vectorizer, or hash vectorizer at word or character level. In an embodiment, text vectorization may involve custom vectorization, where the unigram tokens may be generated using combinations of one or more groups of unigrams based on user configured combinations of features in a preprocessing step. These further may be vectorized using a unigram vectorizer to generate relevant features. A number of features may be reduced by using an appropriate feature selection method such as mutual information, Principal Component Analysis (PCA), Singular Value Decomposition (SVD), Chi-square, Gain ratio, Gini index, and the like. The reduced set of features may then be fed to be persona classification algorithm to identify at least one persona for the customer. Further, the system 300 may be configured to predict a likelihood of the customer to interact with the customer support representative based on the predicted at least one persona. In at least one example embodiment, a number of advertisements and the type of engagements offered in the advertisements may be determined based on the predicted likelihood of the customer to interact with the customer support representative.

In at least one example embodiment, the processor 302 is configured to, with the content of the memory 304, cause the system 300 to determine a bid amount for each advertisement. The bid amount may be determined based, at least in part, on a type of customer engagement. The type of engagement, as explained above, may correspond to one of a chat interaction with a human agent, a chat interaction with an automated agent, an interactive voice response (IVR) interaction with an automated agent, a voice interaction with a human agent, and the like. In at least one example embodiment, the processor 302 is configured to, with the content of the memory 304, cause the system 300 to facilitate bidding for the display of one or more advertisements on an advertisement display space available on the Web domain based on the determined bid amount for the each advertisement, as explained in further detail with reference to FIG. 7.

FIG. 7 depicts a block diagram of an advertisement network 700 connecting enterprises to prospective customers in accordance with an embodiment. The advertisement network 700 includes an advertisement exchange 702 (hereinafter referred to as ad exchange 702) including a demand side platform (DSP) 704 and a supply side platform (SSP) 706. The DSP 704 is configured to be in communication with a plurality of advertising agencies, such as an advertising agency 708, to receive bids for advertisements on behalf of advertisers, i.e. enterprises, such as the advertiser 710. The advertisers along with advertising agencies and the DSP 704 configure a buy side component of the advertisement network 700.

Enterprises wishing to engage with prospective customers may wish to advertise using both on-domain advertising and off-domain advertising. Accordingly, the enterprises (also interchangeably referred to herein as advertisers) may contract advertising agencies to generate creative advertisements. The advertisement agencies also referred to herein as ‘ad agencies’ may scout for possible options for placing the creative advertisements and select the most optimal options such as, for example, available ad space on popular Web domains, such as those related to Web search engine service providing Websites, e-commerce Websites, popular blogs, popular new sites, etc. Typically, many advertisers seek to place advertisements on limited available ad space on such domains. In many example scenarios, the ad exchange 702 is configured to implement a bidding scheme, whereby a highest bidder is awarded the ad space.

The SSP 706 of the ad exchange 702 is further configured to be in communication with an advertisement (ad) server 712 which, in turn, is configured to display the advertisements on publisher Websites, such as the Web search engine service providing Websites, e-commerce Websites, popular blogs, popular new sites, etc. to be viewed by prospective customers visiting these Websites. The publisher Websites and the prospective customers are exemplarily depicted using a representative publisher Website 714 and a representative customer 716 in FIG. 7. The ad server 712 along with publisher Website 714, the customer 716, and the SSP 706 configures a sell side component of the advertisement network 700.

The advertisement network 700 further includes the system 300 explained with reference to FIG. 3. The system 300 is configured to be in communication with the third party data gathering servers 752, existing and potential customers, such as the customer 716, the advertising agencies, such as the advertising agency 708, the advertisement server 712, and the ad exchange 702. The system 300 includes a plurality of channel interfaces in the communication interface 308 (not shown in FIG. 7), which facilitates communication with such remote entities over a communication network, such as the network explained with reference to FIG. 1. The system 300 is configured to collate information corresponding to a plurality of customers of an enterprise from various enterprise interaction channels used by the customers to communicate with the enterprise. In at least one example embodiment, based on the collated information, the system 300 is configured to identify persona types and also determine a likelihood of a customer associated with a particular persona type to initiate an interaction with a customer support representative or initiate a purchase transaction for an enterprise offering. The system 300 is further configured to suggest bid amounts to the advertising agencies, such as the advertising agency 708, for optimizing a likelihood of the customer engaging with the enterprise. In an embodiment, the bid amounts may vary based on the type of engagement offered to the customer and the persona type. For example, if the system 300 determines that queries related to an enterprise product by customers of a particular persona type may be adequately addressed by a virtual assistant, i.e. automated agents, without requiring services of a live agent, thereby lowering cost, then the system 300 may be configured to suggest inclusion of such an assistance with an appropriate bid amount (for example, US$5.00) to the advertising agency 708.

In at least one example embodiment, the advertising agency 708 may be configured to receive such information from the system 300 and include a section, such as the section 508 depicted in the advertisement 502 in FIG. 5 (or the button 410 in the advertisement 402 shown in FIG. 4), and place the suggested bid amount to initiate bidding process for a desired ad space on a Web domain. It is understood that differential bid amounts, for example US$5.00 for virtual assistant services, $10 for interactive voice response services, and $15 for live chat agent or live voice agent, may be placed with the ad exchange 702. If the placed bids are selected, then advertisements, such as the advertisement 402, may be displayed on the Web domains. Prospective customers visiting the Web domains may be more inclined to click on such advertisements as their queries may be instantly answered, thereby increasing the efficacy of the advertisements and improving the online experience of the customers. The provisioning of advertisements is further explained with reference to illustrative examples below.

In an example scenario, a prospective customer wishing to purchase a television (TV) may perform a search on a Web search engine using key words ‘XYZ Enterprise TV best deals.’ Based on the keywords and other information collated, such as device type, operating system type, geography, and other third party data, the system 300 may predict the persona of the customer to be ‘a discount seeker.’ For the combination of the persona type ‘discount seeker’ and the key word input provided by the client, the system 300 may suggest the advertising agency 708 to bid (on behalf of the advertiser 710) for a display ad at $10 bid price, plus a $5 component for virtual assistant (VA) assisted advertisement. The customer is shown a personalized display ad by “XYZ.com” for a TV, on the appropriate ad slot by the ad server 712. The customer clicks on the ad and is directed to a domain in the VA “XYZ.com TV” queue. The customer gets a personalized virtual assistant (VA) greeting (I can help you select the best priced TVs. We currently have good discount offers”). The VA model is trained to answer customer queries related to TVs and the VA is further configured to prompt the customer to make a purchase upon successfully answering the customer's queries. The VA may further be configured to help the customer complete the purchase transaction.

In another example scenario, a prospective customer wishing to purchase a laptop may perform a search on an e-commerce website, i.e. publisher Website 714, using key words ‘laptops.’ Based on the keyword and other information collated, such as device type, operating system type, geography, and other third party data, the system 300 may predict the persona of the customer to be ‘a high value’ customer. For the combination of the persona type ‘high value’ and the key word input provided by the client, the system 300 may suggest the advertising agency 708 to bid on behalf of the laptop enterprise, i.e. advertiser 710, for a display ad at $15 bid price, plus a $10 component for chat assisted advertisement.

The customer is shown a personalized display ad by “Laptop.com” for a laptop, on the appropriate ad slot by the ad server 712. The customer clicks on the ad and is directed to a domain in the “laptop.com ABC laptop” chat queue. A chat agent assists the customer with the options of laptops and pushes a sliding notification to show various options. The chat agent further pushes a credit card sliding notification to close the sale of a recommended product.

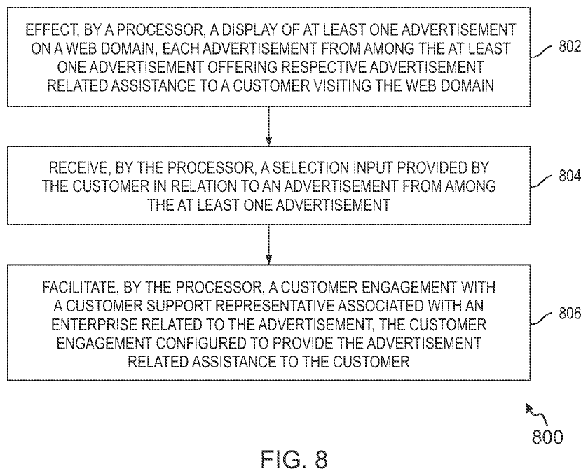

A method for facilitating a provisioning of advertisements to customers is explained with reference to FIG. 8.

FIG. 8 is a flow diagram of an example method 800 for facilitating provisioning of advertisements to customers in accordance with an embodiment of the invention. The method 800 depicted in the flow diagram may be executed by, for example, the system 300 explained with reference to FIGS. 3 to 7. Operations of the flowchart, and combinations of operation in the flowchart, may be implemented by, for example, hardware, firmware, a processor, circuitry, and/or a different device associated with the execution of software that includes one or more computer program instructions. The operations of the method 800 are described herein with help of the system 300. For example, one or more operations corresponding to the method 800 may be executed by a processor, such as the processor 302 of the system 300. Although the one or more operations are explained herein to be executed by the processor alone, the processor is associated with a memory, such as the memory 304 of the system 300, which is configured to store machine executable instructions for facilitating the execution of the one or more operations. The operations of the method 800 can be described and/or practiced by using a system other than the system 300. The method 800 starts at operation 802.

At operation 802 of the method 800, display of at least one advertisement on a Web domain is effected by a processor, such as the processor 302 of the system 300 explained with reference to FIG. 3. Each advertisement is configured to offer respective advertisement related assistance to a customer visiting the Web domain. Some examples of advertisements offering advertisement related assistance are depicted in FIGS. 4 and 5. In some embodiments, one or more advertisements are displayed to the customer on the Web domain in response to the textual input provided by the customer on the Web domain. In some embodiments, the textual input may be used to predict at least one persona based on the textual input and other information, such as device information, and thereafter predict a likelihood of the customer to engage in an interaction with a customer support representative. Based on such prediction, one or more advertisements may be offered to the customer on the Web domain. The system 300 may be configured to interact with an ad exchange, such as the ad exchange 702 explained with reference to FIG. 7, to facilitate provisioning of advertisements to the customer.

At operation 804 of the method 800, a selection input provided by the customer in relation to an advertisement from among the at least one advertisement is received by the processor. A customer may provide a click or a touch input on the advertisement to provide the selection input. At operation 806 of the method 800, in response to the selection input provided by the customer, a customer engagement with a customer support representative associated with an enterprise related to the advertisement is facilitated by the processor. In an embodiment, the type of engagement may correspond to one of a chat interaction with a human agent, a chat interaction with an automated agent, an interactive voice response (IVR) interaction with an automated agent, a voice interaction with a human agent, and the like. The customer engagement is configured to provide the advertisement related assistance to the customer. The facilitation of the customer engagement with the customer support representative is explained with reference to FIGS. 6 and 7 and is not explained again herein.

Although the method 800 is explained with reference to a single prospective customer visiting a Web domain, the method 800 may be extended to provision advertisements enabling engagement with enterprise for a plurality of prospective customers visiting various Web domains. Moreover, provisioning of advertisements enabling engagement or offering assistance may not be limited to only Web domains, but such advertisements may be provided on other off-domain channels, such as SMS, email, and the like.

Various embodiments disclosed herein provide numerous advantages. The techniques disclosed herein suggest provisioning of advertisements that are capable of providing assistance to the customer. More specifically, the advertisements are configured in such a manner that the customer may click on the advertisement and connect to a customer support representative to have queries answered or receive additional information related to a product or service being advertised. In at least one example embodiment, a system, such as the system 300 further has predictive modeling, customer segmentation and recommendation modules to recommend the appropriate channel of engagement to customer over ads. The appropriate ad impressions with the recommended engagement channel are displayed to the target audience on a publisher Website. The target audience can interact with agents or virtual agents available to service the customers through the system. This leads to better customer experience for the customer and further enables higher conversion and click through rates for the enterprise. It would also enable servicing a larger audience with propensity to buy off-domain, increasing the revenues for the enterprises. Moreover, such an approach enables the enterprise to reach out to a much higher volume of customers as well as drive higher revenues through effective bidding. Further, such approach improves operation of the system and network by making efficient use of system resources and network bandwidth.

Although the invention has been described with reference to specific exemplary embodiments, it is noted that various modifications and changes may be made to these embodiments without departing from the broad spirit and scope of the invention. For example, the various operations, blocks, etc., described herein may be enabled and operated using hardware circuitry (for example, complementary metal oxide semiconductor (CMOS) based logic circuitry), firmware, software and/or any combination of hardware, firmware, and/or software (for example, embodied in a machine-readable medium). For example, the apparatuses and methods may be embodied using transistors, logic gates, and electrical circuits (for example, application specific integrated circuit (ASIC) circuitry and/or in Digital Signal Processor (DSP) circuitry).

Particularly, the apparatus 300, the processor 302, the memory 304, the I/O module 306 and the communication interface 308 may be enabled using software and/or using transistors, logic gates, and electrical circuits (for example, integrated circuit circuitry such as ASIC circuitry). Various embodiments of the present technology may include one or more computer programs stored or otherwise embodied on a computer-readable medium, wherein the computer programs are configured to cause a processor or computer to perform one or more operations (for example, operations explained herein with reference to FIG. 8). A computer-readable medium storing, embodying, or encoded with a computer program, or similar language, may be embodied as a tangible data storage device storing one or more software programs that are configured to cause a processor or a computer to perform one or more operations. Such operations may be, for example, any of the steps or operations described herein. In some embodiments, the computer programs may be stored and provided to a computer using any type of non-transitory computer readable media. Non-transitory computer readable media include any type of tangible storage media. Examples of non-transitory computer readable media include magnetic storage media (such as floppy disks, magnetic tapes, hard disk drives, etc.), optical magnetic storage media (e.g. magneto-optical disks), CD-ROM (compact disc read only memory), CD-R (compact disc recordable), CD-R/W (compact disc rewritable), DVD (Digital Versatile Disc), BD (BLU-RAY® Disc), and semiconductor memories (such as mask ROM, PROM (programmable ROM), EPROM (erasable PROM), flash memory, RAM (random access memory), etc.). Additionally, a tangible data storage device may be embodied as one or more volatile memory devices, one or more non-volatile memory devices, and/or a combination of one or more volatile memory devices and non-volatile memory devices. In some embodiments, the computer programs may be provided to a computer using any type of transitory computer readable media. Examples of transitory computer readable media include electric signals, optical signals, and electromagnetic waves. Transitory computer readable media can provide the program to a computer via a wired communication line (e.g. electric wires, and optical fibers) or a wireless communication line.

Various embodiments of the invention, as discussed above, may be practiced with steps and/or operations in a different order, and/or with hardware elements in configurations, which are different than those which, are disclosed. Therefore, although the invention has been described based upon these exemplary embodiments, it is noted that certain modifications, variations, and alternative constructions may be apparent and well within the spirit and scope of the invention.

Although various exemplary embodiments of the invention are described herein in a language specific to structural features and/or methodological acts, the subject matter defined in the appended claims is not necessarily limited to the specific features or acts described above. Rather, the specific features and acts described above are disclosed as exemplary forms of implementing the claims.

1. A computer-implemented method, comprising:
with a processor:
displaying to a customer at least one advertisement on a Web domain;
receiving a textual input provided by the customer visiting the Web domain;
effecting the display of the at least one advertisement at least in part based on the textual input;
analyzing said textual input to identify behavioral traits associated with the customer during interactions of the customer with the Web domain, said analyzing comprising any of text tokenization, text normalization, and text vectorization on elements of the textual input to generate a plurality of features;
using a feature selection method to reduce a number of said features;
feeding said reduced set of features to a persona classification algorithm to identify at least one persona for the customer, said persona comprising characteristics reflecting behavioral patterns, goals, motives, and personal values of the customer, said persona further comprising a persona type that reflects behavioral similarity, or similarity in goals and motives with other customers within one or more customer persona classification frameworks or taxonomies that facilitate a segregation of customers based on customer personas types;
predicting a likelihood of the customer to interact with a customer support representative based on the predicted at least one persona; and
based on said predicting, connecting said customer with a customer support representative associated with an enterprise related to the advertisement.

2. The method as claimed in claim 1, further comprising:
determining, by the processor, a bid amount for each advertisement from among the at least one advertisement, wherein the bid amount is determined based, at least in part, on a type of customer engagement.

3. The method as claimed in claim 2, wherein the type of customer engagement corresponds to one of a chat interaction with a human agent, a chat interaction with an automated agent, an interactive voice response (IVR) interaction with an automated agent, and a voice interaction with a human agent.

4. The method as claimed in claim 2, further comprising:
facilitating, by the processor, bidding for the display of the at least one advertisement on an advertisement display space available on the Web domain based on the determined bid amount for each advertisement.

5. The method as claimed in claim 1, wherein each advertisement from among the at least one advertisement corresponds to one of an off-domain advertisement and an on-domain advertisement.

6. A system, comprising:
at least one processor; and
a memory having stored therein machine executable instructions, that when executed by the at least one processor, cause the system to:
display to a customer at least one advertisement on a Web domain;
receive a textual input provided by the customer visiting the Web domain;
effect the display of the at least one advertisement at least in part based on the textual input;
analyze said textual input to identify behavioral traits associated with the customer during interactions of the customer with the Web domain, said analyzing comprising any of text tokenization, text normalization, and text vectorization on elements of the textual input to generate a plurality of features;
use a feature selection method to reduce a number of said features;
feed said reduced set of features to a persona classification algorithm to identify at least one persona for the customer, said persona comprising characteristics reflecting behavioral patterns, goals, motives, and personal values of the customer, said persona further comprising a persona type that reflects behavioral similarity, or similarity in goals and motives with other customers within one or more customer persona classification frameworks or taxonomies that facilitate a segregation of customers based on customer personas types;
predict a likelihood of the customer to interact with a customer support representative based on the predicted at least one persona; and
based on said predicting, connect said customer with a customer support representative associated with an enterprise related to the advertisement.

7. The system as claimed in claim 6, wherein the system is further caused to:
determine a bid amount for each advertisement from among the at least one advertisement, wherein the bid amount is determined based, at least in part, on a type of customer engagement.

8. The system as claimed in claim 7, wherein the type of customer engagement corresponds to one of a chat interaction with a human agent, a chat interaction with an automated agent, an interactive voice response (IVR) interaction with an automated agent, and a voice interaction with a human agent.

9. The system as claimed in claim 7, wherein the system is further caused to:
facilitate bidding for the display of the at least one advertisement on an advertisement display space available on the Web domain based on the determined bid amount for each advertisement.

10. The system as claimed in claim 7, wherein each advertisement from among the at least one advertisement corresponds to one of an off-domain advertisement and an on-domain advertisement.

11. The system as claimed in claim 7, wherein the system is further caused to:
additionally provision the at least one advertisement as any of one of a short message service (SMS) advertisement and an email advertisement to one or more customers of the enterprise.

12. A computer-implemented method, comprising:
effecting, by a processor, display of at least one advertisement on an electronic device of a customer of an enterprise, each advertisement from among the at least one advertisement offering respective advertisement related assistance to the customer;
receiving, by the processor, a selection input provided by the customer in relation to an advertisement from among the at least one advertisement;
receiving, by the processor, a textual input provided by the customer visiting the Web domain;
effecting the display of the at least one advertisement at least in part based on the textual input;
analyzing said textual input to identify behavioral traits associated with the customer during interactions of the customer with the Web domain, said analyzing comprising any of text tokenization, text normalization, and text vectorization on elements of the textual input to generate a plurality of features;
using a feature selection method to reduce a number of said features;
feeding said reduced set of features to a persona classification algorithm to identify at least one persona for the customer, said persona comprising characteristics reflecting behavioral patterns, goals, motives, and personal values of the customer, said persona further comprising a persona type that reflects behavioral similarity, or similarity in goals and motives with other customers within one or more customer persona classification frameworks or taxonomies that facilitate a segregation of customers based on customer personas types;
predicting a likelihood of the customer to interact with a customer support representative based on the predicted at least one persona; and
based on said predicting, connecting said customer with a customer support representative associated with an enterprise related to the advertisement.

13. The method as claimed in claim 12, wherein an advertisement from among the at least one advertisement corresponds to one of a SMS advertisement and an Email advertisement.

14. The method as claimed in claim 13, wherein the at least one advertisement is displayed as part of a Web domain accessed by the customer using the electronic device.
